(19) United States
(12) Patent Application Publication
(10) Pub. No.: US 2025/0365328 A1
(43) Pub. Date: Nov. 27, 2025

(54) Systems and Methods for Providing Rich Call Data

(71) Applicant: Comcast Cable Communications, LLC, Philadelphia, PA (US)

(72) Inventors: Alex Model, Penn Valley, PA (US); Vengatarajulu Rajasekar, Mount Laurel, NJ (US); Eric Wong, Edison, NJ (US); Charles Henry, Philadelphia, PA (US)

(21) Appl. No.: 18/670,023

(22) Filed: May 21, 2024

(51) Int. Cl. H04L 65/1096

(52) U.S. Cl. CPC H04L 65/1096

(57) ABSTRACT

Systems, apparatuses, and methods are described for tracking and monitoring access of Rich Call Data (RCD). An RCD system may append call invites with unique links. The RCD system may determine if a recipient device is configured to access RCD by maintaining records relating to access of the unique links.

### BACKGROUND

Rich Call Data enables entities to deliver information with call invites so that receivers of the call invite can access information associated with the call. The call invite may include information such as a brand logo or reason for the call. Receivers of the call invites are more likely to answer calls if they know the source and reason for the call.

### SUMMARY

The following summary presents a simplified summary of certain features. The summary is not an extensive overview and is not intended to identify key or critical elements.

Rich Call Data (RCD) may help persuade users to answer phone calls, for example, by showing the name of the caller and other optional information associated with the caller, such as a logo image, photo, avatar, video, or reason for the call. RCD may be defined to enable the exchange of links to multi-media files, for example, in the Session Initiation Protocol (SIP) call invite. The receiving handset may access the links in the call invite, for example, via an available data connection and render the content (e.g., a company logo). However, RCD specifications may lack methods for tracking if RCD multi-media links have been accessed by a handset that is capable of displaying such RCD multi-media links. RCD specifications may also fail to offer real-time notification of RCD information. Disclosed herein are systems, apparatuses, and methods to deliver real-time (or near real-time) notification to the calling party, for example, by using the unique call specific identifier and allowing the originating carrier to track if RCD multi-media links are accessed by the called party, for example, using a unique call specific identifier embedded in the link. The originating service provider may then track access and usage by the call identifier (e.g., a specific individual call identifier) and offer metric reports (e.g., improvement of call answer rates compared to calls where RCD data is not accessed). These features may provide advantages, such as revenue sharing with mobile carriers when RCD is displayed to the terminating user as opposed to a call invite with RCD that was sent to a peering partner.

These and other features and advantages are described in greater detail below.

### BRIEF DESCRIPTION OF THE DRAWINGS

Some features are shown by way of example, and not by limitation, in the accompanying drawings. In the drawings, like numerals reference similar elements.

FIG. 1 shows an example communication network.

FIG. 2 shows hardware elements of a computing device.

FIG. 3 shows an example mobile and fixed communication network.

FIG. 4 shows an example mobile and fixed communication network configured to send Rich Call Data (RCD).

FIG. 5 is a flow chart showing an example method for recording access of RCD by terminating receivers.

FIG. 6 is a flow chart showing an example method for sending a call invite containing RCD to terminating receivers.

FIG. 7 is a flow chart depicting an example method for recording access of RCD.

FIG. 8 is a flow charting depicting an example method for recording sending call invites with RCD and recording access

FIG. 9A is a flow chart depicting an example method for real time notification for detecting access of RCD by terminating receivers.

FIG. 9B shows examples of the advantages provided by the RCD access record using a unique link.

FIGS. 10A-D is a sequence diagram depicting an example sequence for recording access and live notification of RCD.

FIGS. 11A and 11B show an example device accessing RCD before and after accepting a call invite.

### DETAILED DESCRIPTION

The accompanying drawings, which form a part hereof, show examples of the disclosure. It is to be understood that the examples shown in the drawings and/or discussed herein are non-exclusive and that there are other examples of how the disclosure may be practiced.

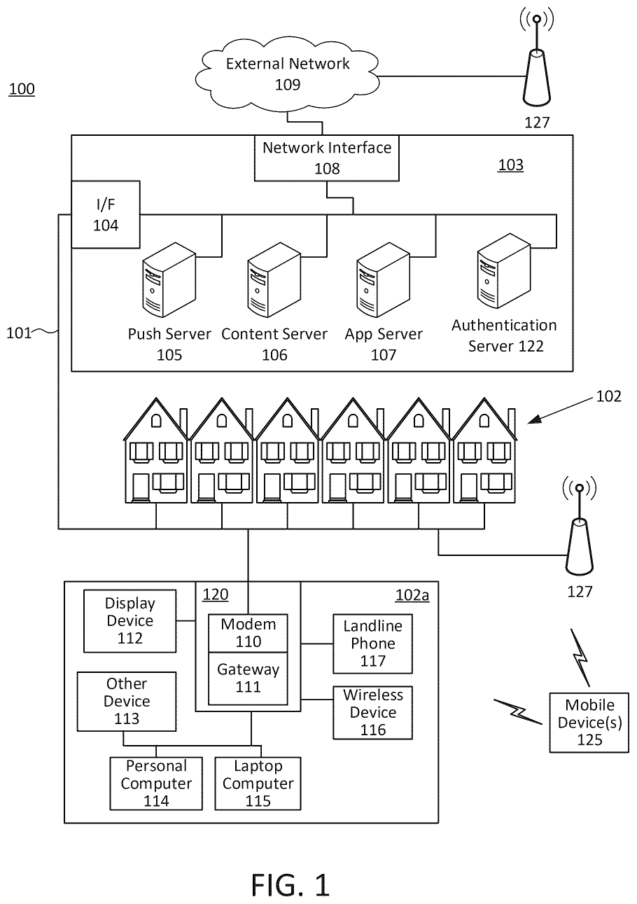

FIG. 1 shows an example communication network 100 in which features described herein may be implemented. The communication network 100 may comprise one or more information distribution networks of any type, such as, without limitation, a telephone network, a wireless network (e.g., an LTE network, a 5G network, a WiFi IEEE 802.11 network, a WiMAX network, a satellite network, and/or any other network for wireless communication), an optical fiber network, a coaxial cable network, and/or a hybrid fiber/coax distribution network. The communication network 100 may use a series of interconnected communication links 101 (e.g., coaxial cables, optical fibers, wireless links, etc.) to connect multiple premises 102 (e.g., businesses, homes, consumer dwellings, train stations, airports, etc.) to a local office 103 (e.g., a headend). The local office 103 may send downstream information signals and receive upstream information signals via the communication links 101. Each of the premises 102 may comprise devices, described below, to receive, send, and/or otherwise process those signals and information contained therein.

The communication links 101 may originate from the local office 103 and may comprise components not shown, such as splitters, filters, amplifiers, etc., to help convey signals clearly. The communication links 101 may be coupled to one or more wireless access points 127 configured to communicate with one or more mobile devices 125 via one or more wireless networks. The mobile devices 125 may comprise smart phones, tablets or laptop computers with wireless transceivers, tablets or laptop computers communicatively coupled to other devices with wireless transceivers, and/or any other type of device configured to communicate via a wireless network.

The local office 103 may comprise an interface 104. The interface 104 may comprise one or more computing devices configured to send information downstream to, and to receive information upstream from, devices communicating with the local office 103 via the communications links 101. The interface 104 may be configured to manage communications among those devices, to manage communications between those devices and backend devices such as servers 105-107 and 122, and/or to manage communications between those devices and one or more external networks 109. The interface 104 may, for example, comprise one or more routers, one or more base stations, one or more optical line terminals (OLTs), one or more termination systems (e.g., a modular cable modem termination system (M-CMTS) or an integrated cable modem termination system (I-CMTS)), one or more digital subscriber line access modules (DSLAMs), and/or any other computing device(s). The local office 103 may comprise one or more network interfaces 108 that comprise circuitry needed to communicate via the external networks 109. The external networks 109 may comprise networks of Internet devices, telephone networks, wireless networks, wired networks, fiber optic networks, and/or any other desired network. The local office 103 may also or alternatively communicate with the mobile devices 125 via the interface 108 and one or more of the external networks 109, e.g., via one or more of the wireless access points 127.

The push notification server 105 may be configured to generate push notifications to deliver information to devices in the premises 102 and/or to the mobile devices 125. The content server 106 may be configured to provide content to devices in the premises 102 and/or to the mobile devices 125. This content may comprise, for example, video, audio, text, web pages, images, files, etc. The content server 106 (or, alternatively, an authentication server) may comprise software to validate user identities and entitlements, to locate and retrieve requested content, and/or to initiate delivery (e.g., streaming) of the content. The application server 107 may be configured to offer any desired service. For example, an application server may be responsible for collecting, and generating a download of, information for electronic program guide listings. Another application server may be responsible for monitoring user viewing habits and collecting information from that monitoring for use in selecting advertisements. Yet another application server may be responsible for formatting and inserting advertisements in a video stream being transmitted to devices in the premises 102 and/or to the mobile devices 125. The local office 103 may comprise additional servers, such as the authentication server 122 (described below), additional push, content, and/or application servers, and/or other types of servers. Although shown separately, the push server 105, the content server 106, the application server 107, the authentication server 122, and/or other server(s) may be combined. The servers 105, 106, 107, and 122, and/or other servers, may be computing devices and may comprise memory storing data and also storing computer executable instructions that, when executed by one or more processors, cause the server(s) to perform steps described herein.

An example premises 102a may comprise an interface 120. The interface 120 may comprise circuitry used to communicate via the communication links 101. The interface 120 may comprise a modem 110, which may comprise transmitters and receivers used to communicate via the communication links 101 with the local office 103. The modem 110 may comprise, for example, a coaxial cable modem (for coaxial cable lines of the communication links 101), a fiber interface node (for fiber optic lines of the communication links 101), twisted-pair telephone modem, a wireless transceiver, and/or any other desired modem device. One modem is shown in FIG. 1, but a plurality of modems operating in parallel may be implemented within the interface 120. The interface 120 may comprise a gateway 111. The modem 110 may be connected to, or be a part of, the gateway 111. The gateway 111 may be a computing device that communicates with the modem(s) 110 to allow one or more other devices in the premises 102a to communicate with the local office 103 and/or with other devices beyond the local office 103 (e.g., via the local office 103 and the external network(s) 109). The gateway 111 may comprise a set-top box (STB), digital video recorder (DVR), a digital transport adapter (DTA), a computer server, and/or any other desired computing device.

The gateway 111 may also comprise one or more local network interfaces to communicate, via one or more local networks, with devices in the premises 102a. Such devices may comprise, e.g., display devices 112 (e.g., televisions), other devices 113 (e.g., a DVR or STB), personal computers 114, laptop computers 115, wireless devices 116 (e.g., wireless routers, wireless laptops, notebooks, tablets and netbooks, cordless phones (e.g., Digital Enhanced Cordless Telephone-DECT phones), mobile phones, mobile televisions, personal digital assistants (PDA)), landline phones 117 (e.g., Voice over Internet Protocol-VoIP phones), and any other desired devices. Example types of local networks comprise Multimedia Over Coax Alliance (MoCA) networks, Ethernet networks, networks communicating via Universal Serial Bus (USB) interfaces, wireless networks (e.g., IEEE 802.11, IEEE 802.15, Bluetooth), networks communicating via in-premises power lines, and others. The lines connecting the interface 120 with the other devices in the premises 102a may represent wired or wireless connections, as may be appropriate for the type of local network used. One or more of the devices at the premises 102a may be configured to provide wireless communications channels (e.g., IEEE 802.11 channels) to communicate with one or more of the mobile devices 125, which may be on- or off-premises.

The mobile devices 125, one or more of the devices in the premises 102a, and/or other devices may receive, store, output, and/or otherwise use assets. An asset may comprise a video, a game, one or more images, software, audio, text, webpage(s), and/or other content.

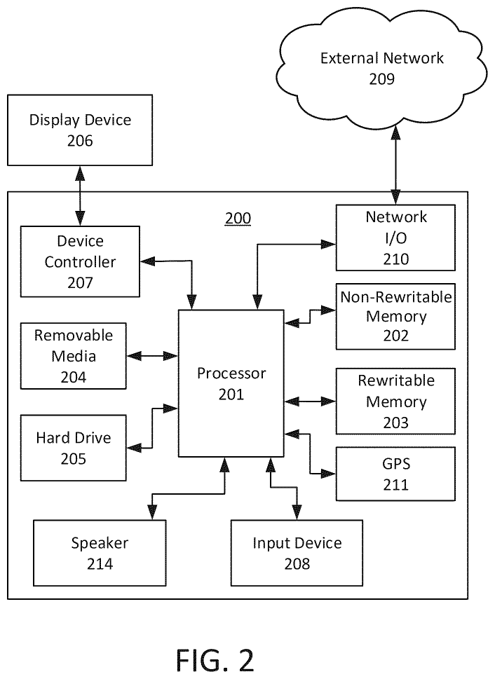

FIG. 2 shows hardware elements of a computing device 200 that may be used to implement any of the computing devices shown in FIG. 1 (e.g., the mobile devices 125, any of the devices shown in the premises 102a, any of the devices shown in the local office 103, any of the wireless access points 127, any devices with the external network 109) and any other computing devices discussed herein (e.g., a Rich Call Data (RCD) system, originating network 303, one or more transit networks 305, and a terminating network 307). The computing device 200 may comprise one or more processors 201, which may execute instructions of a computer program to perform any of the functions described herein. The instructions may be stored in a non-rewritable memory 202 such as a read-only memory (ROM), a rewritable memory 203 such as random-access memory (RAM) and/or flash memory, removable media 204 (e.g., a USB drive, a compact disk (CD), a digital versatile disk (DVD)), and/or in any other type of computer-readable storage medium or memory. Instructions may also be stored in an attached (or internal) hard drive 205 or other types of storage media. The computing device 200 may comprise one or more output devices, such as a display device 206 (e.g., an external television and/or other external or internal display device) and a speaker 214, and may comprise one or more output device controllers 207, such as a video processor or a controller for an infra-red or BLUETOOTH transceiver. One or more user input devices 208 may comprise a remote control, a keyboard, a mouse, a touch screen (which may be integrated with the display device 206), microphone, etc. The computing device 200 may also comprise one or more network interfaces, such as a network input/output (I/O) interface 210 (e.g., a network card) to communicate with an external network 209. The network I/O interface 210 may be a wired interface (e.g., electrical, RF (via coax), optical (via fiber)), a wireless interface, or a combination of the two. The network I/O interface 210 may comprise a modem configured to communicate via the external network 209. The external network 209 may comprise the communication links 101 discussed above, the external network 109, an in-home network, a network provider's wireless, coaxial, fiber, or hybrid fiber/coaxial distribution system (e.g., a DOCSIS network), or any other desired network. The computing device 200 may comprise a location-detecting device, such as a global positioning system (GPS) microprocessor 211, which may be configured to receive and process global positioning signals and determine, with possible assistance from an external server and antenna, a geographic position of the computing device 200.

Although FIG. 2 shows an example hardware configuration, one or more of the elements of the computing device 200 may be implemented as software or a combination of hardware and software. Modifications may be made to add, remove, combine, divide, etc. components of the computing device 200. Additionally, the elements shown in FIG. 2 may be implemented using basic computing devices and components that have been configured to perform operations such as are described herein. For example, a memory of the computing device 200 may store computer-executable instructions that, when executed by the processor 201 and/or one or more other processors of the computing device 200, cause the computing device 200 to perform one, some, or all of the operations described herein. Such memory and processor(s) may also or alternatively be implemented through one or more Integrated Circuits (ICs). An IC may be, for example, a microprocessor that accesses programming instructions or other data stored in a ROM and/or hardwired into the IC. For example, an IC may comprise an Application Specific Integrated Circuit (ASIC) having gates and/or other logic dedicated to the calculations and other operations described herein. An IC may perform some operations based on execution of programming instructions read from ROM or RAM, with other operations hardwired into gates or other logic. Further, an IC may be configured to output image data to a display buffer.

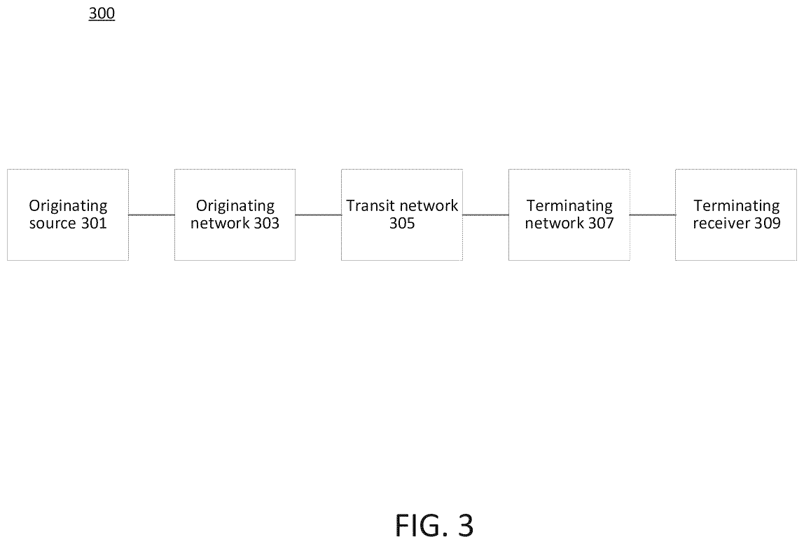

FIG. 3 shows an example system 300 for sending a call from an originating source 301 to a terminating receiver 309 As shown in FIG. 3, a system for sending a call invite may include an originating source 301, an originating network 303, one or more transit networks 305, a terminating network 307, and a terminating computing device.

As shown in FIG. 3, originating source 301 may be a device capable of sending call invites (e.g., it may be a telephone, a computing device capable sending phone calls over IP networks, or unit in an enterprise call center). Originating source 301 may be a device capable of sending call or communication invites to other devices. The originating source 301 may be compatible with SIP and other VOIP calling standards. The call invite may be a Session Initiation Protocol (SIP) invite or comply with any standard capable of supporting RCD. The call invite may include information relating to the identity of the originating source (i.e., it will include the originating source ID and/or phone number).

The originating network may be configured to receive a call invitation generated by originating source 301. Originating network 303 may comprise other sub-systems such as one or more billing servers, a call log server, and an authentication system. The sub-systems may be capable of receiving the call invite received from originating source 301 and may be further capable of manipulating the call invite. Originating network 303 may, after manipulating the call invite through one or more operations, send the call invite to the one or more transit networks 305. The one or more transit networks 305 may send the call invite to terminating network 307. Terminating network 307 may comprise one or more sub-systems such as one or more billing servers, a call log server, an authentication system

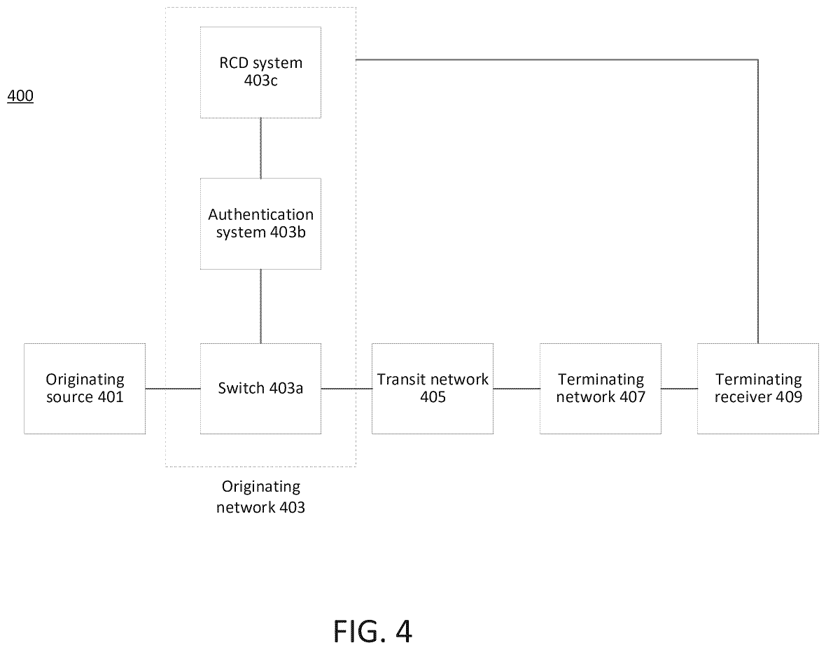

FIG. 4 shows a system 400 for sending RCD associated with a call invite. As shown, system 400 may comprise an originating source 401. In some instances, originating source 401 may be similar to originating source 301, but the disclosure is not so limited. The originating source 401 may send a call invite from an entity (e.g., an individual, a business, an organization, etc.) that may have an originating ID associated with all or a portion of the calling number of the entity. In some instances, an entity may have multiple phone numbers, each indicating different information relating to the purpose or specific origin of the call (e.g., department, type of personnel, location of personnel, etc.). Moreover, in instances where an entity has multiple phone numbers, each phone number may be subscribed to different RCD profiles.

FIG. 4 also depicts an originating network 403. The originating network 403 may be similar to network 303 depicted in FIG. 3, but the disclosure is not so limiting. Additionally, originating network 403 may further comprise other systems such as a switch 403a for routing call invites and responses, a billing server, a call log server, an authentication system 403b (authentication system 403b may comprise authentication server 122, but it may also comprise a variety of different servers or systems in addition to or instead of authentication server 122) and an RCD system 403c. In some instances, the authentication system 403b may be implemented as a STIR/SHAKEN system or server. A STIR/SHAKEN system or server may be integrated into one or more of the sub-systems of system 400. The STIR/SHAKEN system may determine if a call invite from originating source 401 should be granted a level of attestation corresponding to a certain level of security. The STIR/SHAKEN system may assign one of three levels of attestation to the originating source 401: (A) full attestation; (B) partial attestation; or (C) gateway attestation. (e.g., the call invite's header would be appended with the level of attestation). The different levels of security are intended to aid receivers of the call invite in differentiating between trusted callers and untrusted callers (i.e., to stop spoof calls). Typically, an originating network that initially receives the call invite from the originating source may determine if the originating source should be granted a level of attestation.

In the system 400 shown in FIG. 4, one or more of sub-systems (e.g., 401, 403, 403a, 403b, 403c, 405, 407, 409) may be integrated into another system. For example, the authentication system 403b may be a subsystem of the RCD system 403c. The RCD system 403c may further comprise one or more webservers such as an RCD access records server or an RCD media server. The originating source 401 may send a call invite to the terminating source by sending the call invite to a switch of the originating network 403. The originating network 403, after receiving the switch may then send the call invite to a transit network. The transit network may send the call invite to the terminating network 407 which sends the call invite to the terminating receiver 409 The originating network 403 may connect the call invite to one or more authentication systems 403b. The authentication system 403b may determine that the originating ID associated with the number is authentic and be granted a level of attestation corresponding to its authenticity. For example, the authentication system 403b may grant an A-level attestation if the authentication system 403b determines that the originating source (i.e., the caller) is using a verified number and has a legitimate right to use the provided phone number as the caller ID for outgoing calls. The authentication system 403b may grant a B-level attestation if the authentication system 403b can identify the caller but is uncertain to the caller's authorization to the use the specified phone number as the caller ID for outgoing calls. The authentication system 403b may grant a C-level attestation if the authentication system 403b cannot verify the all at A-level or B-level attestation. The authentication system 403b may communicate with the RCD system 403c to determine if the call invite is associated with RCD (e.g., one or more RCD profiles). The originating network 403 may append the originating ID's header with an RCD header relating to an RCD profile of the originating source 401 such as one or more links provided by the RCD relating to the originating user such as a brand logo, icon, a reason for a call, or other media. The media may also be customizable to terminating receiver 409 (e.g., the media may be advertisement targeted to a user of the terminating receiver 409 or it may be relevant to the call reason).

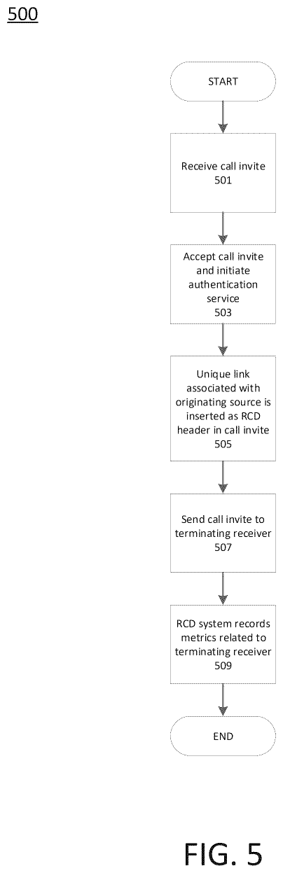

FIG. 5 depicts a method 500 for determining if a terminating receiver is capable of receiving RCD and recording relevant metrics of the terminating receiver. For ease of explanation, FIG. 5 is discussed with reference to previous FIGS. 3 and 4, however, it should be understood that these are just examples and the disclosure is not so limited. As shown in FIG. 5, in method 500, the originating network 403 (e.g., switch 403a) receives a call invite from an originating source (e.g., originating source 301, 401) at 501.

At 503, the originating network 403 (e.g., switch 403a) accepts the call invite and initiates an authentication procedure. The authentication procedure may include the use of a STIR/SHAKEN system. The authentication system (e.g., authentication system 403b as shown in FIG. 4) may assign a level of attestation corresponding to a level of authenticity or security to the originating source 301. For example, in a STIR/SHAKEN framework, the STIR/SHAKEN system may assign one of three levels of attestation to the originating source 301: (A) full attestation; (B) partial attestation; or (C) gateway attestation. (e.g., the call invite's header would be appended with the level of attestation).

At 505, the RCD system 403c may receive the originating ID and determine if the originating ID subscribes to one or more RCD services. For example, an entity may have one phone number and have one RCD profile. An entity may have one phone number and multiple extensions, each subscribing to an RCD profile of the entity. (e.g., billing personnel's extensions may have an RCD profile whereas sales personnel's extensions may have another). An entity may have multiple phone numbers, each indicating different department, type of personnel, location of personnel, etc. The RCD system 403c may add the originating ID's RCD information to a call invite of the originating source 401. The RCD system 403c may add the RCD information by adding a unique link to the call invite. The unique link may refer to a link that enables the RCD system 403c to track and monitor access of the RCD by one or more users and make that RCD information accessible to the terminating receiver 409. For example, the unique link may be a link that is only accessible by one terminating receiver 409. The unique link may be a link that is accessible by more than one user wherein the RCD system 403c is capable of tracking access of the RCD by terminating receivers and correlating that access to other metrics such as the call invite time.

At 507, the originating network 403, after authenticating the call invite and appending the call invite with the unique link, sends the call invite to a recipient device (e.g., terminating receiver 309, 409). The originating network 403 may send the call invite through one or more transit networks (e.g., transit network 305, 405). A terminating network (e.g., terminating network 307, 407 as shown in FIGS. 3 and 4) may receive the call invite. The terminating network 407 may comprise other sub-systems such as one or more of a switch, a billing server, a call log server, and an authentication system. The terminating network 407 or one of its sub-systems may decode one or more headers relating to authentication level, RCD, and originating source ID. The terminating network 407 may perform an authentication procedure, wherein the terminating network may decode the identity headers of the appended call invite and determine if the attestation level granted to the call invite by the authentication system (e.g., authentication system 403a) of the originating network is valid. The terminating network 407 may send the call invite with the validated attestation level to the terminating receiver 409. The terminating receiver 409 may process the call invite. If the terminating receiver 409 is configured to access the RCD media file, it may resolve the unique RCD media file link and issue a fetch request to the RCD system 403c to receive the RCD media file.

At 509, the RCD system 403c may record metrics relating to the terminating receiver 409 and its access of the RCD MEDIA. The metrics may include whether the terminating receiver 409 accessed the unique link, and when it accessed the unique link. The metrics may also include information such as whether the terminating receiver 409 experienced a non-ring event. Non-ring events may be caused by the terminating receiver 409 being in a non-ring state such as a do-not-disturb or other similar setting. The terminating receiver 409 may experience a non-ring event because the terminating receiver is in a powered-off state or is otherwise not connected to the network. The RCD system 403c may determine that a non-ring event has occurred through many mechanisms such as analyzing the number of rings that occurred on a first call, analyzing whether a second call immediately after the first call results in one or more rings. Non-ring events may also be caused by an analytics engine that deems the originating source 401 ID as spam. When the non-ring event is caused by an analytics engine, the RCD system 403c may receive a response from the terminating network 407 indicating that an analytics engine blocked the call (e.g., SIP 603+).

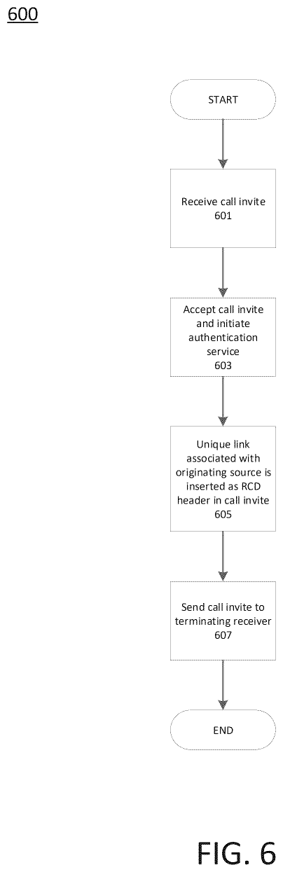

FIG. 6 depicts a method 600 for determining if a terminating receiver is capable of receiving RCD. For ease of explanation, FIG. 6 is discussed with reference to previous FIGS. 3 and 4, however, it should be understood that these are just examples and the disclosure is not so limited. At 601, the originating network (e.g., originating network 303, 403) may receive a call invite from an originating source (e.g., originating source 301, 401).

At 603, the originating network accepts the call invite and initiates an authentication procedure by invoking the services of an authentication system (e.g., authentication system 403b) to grant an attestation level to the call invite. The RCD system (e.g., RCD system 403c) may receive a call invite or information relating to the call invite (e.g., originating source ID) from an originating source (e.g., originating source 301, 401). At 603, the RCD system (e.g., RCD system 403c) accepts the call invite and initiates an authentication procedure. The authentication procedure may include the use of a STIR/SHAKEN system (e.g., authentication system 403b). The authentication system may assign a level of attestation corresponding to a level of authenticity or security to the originating source. For example, in a STIR/SHAKEN framework, the STIR/SHAKEN system may assign one of three levels of attestation to the originating source 301: (A) full attestation; (B) partial attestation; or (C) gateway attestation.

At 605, the originating network 403 may send the call invite or information relating to the call invite (e.g., the originating source ID) to the RCD system 403c. The RCD system 403c receives the originating source ID and determines if the originating source ID subscribes to one or more RCD services. The RCD system 403c may add the originating source ID's RCD profile to the call invite. The RCD system 403c may add a unique link to the call invite. The unique link may refer to a link that enables the RCD system 403c to track and monitor access of the RCD by one or more users. For example, the unique link may be a soft link that is only accessible by one terminating receiver 409. The unique link may be a link that is accessible by more than one user wherein the RCD system 403c is capable of tracking access of the RCD by terminating receivers and correlating that access to time of call.

At 607, the originating network 403, after authenticating the call invite and appending the call invite with the unique link, may send the call invite to a recipient device (e.g., terminating receiver 409). The originating network 403 may send the call invite to terminating receiver 409 by sending the call invite through one or more transit networks (e.g., transit network 305, 405). The one or more transit networks 405 may send the call invite to a terminating network (e.g., terminating network 307, 407). The terminating network 407 may invoke an authentication service of an authentication system of terminating network 407 to decode either or both of the originating source ID and the RCD information. The terminating network 407 may send the call invite to the terminating receiver 409. The terminating receiver 409 may process the call invite, and if it has the capability to support and output the RCD media file, it may resolve the unique RCD media file link and issue a fetch request to the RCD system 403c to receive the RCD media file.

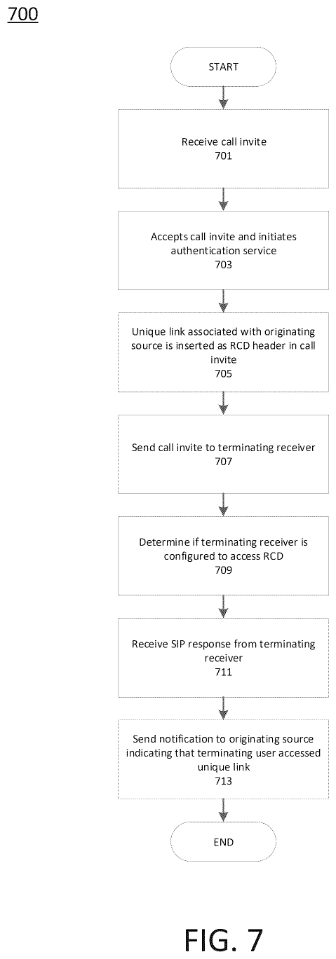

FIG. 7 depicts a method 700 for determining if a terminating receiver is capable of receiving RCD and sending live notification with respect to the determination of whether the terminating receiver is capable of receiving RCD to an originating source. For ease of explanation, FIG. 7 is discussed with reference to previous FIGS. 3 and 4, however, it should be understood that these are just examples and the disclosure is not so limited. As shown in FIG. 7, in method 700, the originating network (e.g., originating network 303, 403) receives a call invite from an originating source (e.g., originating source 301, 401) at 701.

At 703, a switch of the originating network 403 (e.g., switch 403a) accepts the call invite and the originating network 403 initiates an authentication service. The authentication service may be performed by invoking the services of an authentication system (e.g., authentication system 403b). The authentication procedure may include the use of a STIR/SHAKEN system. The authentication system 403b may assign a level of attestation corresponding to a level of authenticity or security to the originating source 401. For example, in a STIR/SHAKEN framework, the STIR/SHAKEN system may assign one of three levels of attestation to the originating source 301: (A) full attestation; (B) partial attestation; or (C) gateway attestation.

At 705, the originating network RCD system 403c receives the originating ID and determines if the originating ID subscribes to one or more RCD services. The RCD system 403c may add the originating ID's RCD profile to the call invite received from originating source 401. The RCD system 403c may add a unique link to the call invite. The unique link may refer to a link that enables the RCD system 403c to track and monitor access of the RCD by one or more users. For example, the unique link may be a soft link that is only accessible by one terminating receiver 309 The unique link may be a link that is accessible by more than one user wherein the RCD system 403c is capable of tracking access of the RCD by terminating receivers and correlating that access to time of call.

At 707, the originating network 403, after authenticating the call invite and appending the call invite with the unique link, sends the call invite to a recipient device (e.g., terminating receiver 309, 409). The originating network may send the call invite to the recipient device by sending the call invite through one or more transit networks (e.g., terminating network 305, 405). The one or more transit networks 405 may send the call invite to a terminating network 407. The terminating network 407 may comprise other sub-systems such as one or more of a switch, a billing server, a call log server, and an authentication system. The terminating network 407 may invoke services of an authentication system (e.g., similar to authentication system 403b, but integrated into the terminating network). The authentication system may decode the call invite for one or more headers such as the originating source ID and the RCD header. The terminating network 307 may send the call invite to the terminating receiver 309 The terminating receiver 309 may process the call invite. If the terminating receiver 309 has the capability to support and output the RCD media file, it may resolve the unique RCD media file link and issue a fetch request to the RCD system 403c to receive the RCD media file.

At 709, the RCD system 403c may determine if the terminating receiver 309 is configured to access RCD. The RCD system 403c may maintain an RCD access record. The RCD access record may be maintained as a sub-system of the RCD system 403c or integrated into RCD system 403c. The RCD access record may be updated by including all or some times of access for each unique link. For example, originating source 401 may send a call invite appended with a unique link in the RCD header to a first terminating receiver (e.g., similar to terminating receiver 309, 409) at a first time and send a call invite appended with the same unique link to a second terminating receiver at a second time. The RCD system 403c may update the RCD access record to indicate whether the unique link was accessed at a first time and/or a second time. The RCD system 403c may determine that the terminating receiver 409 accessed the RCD by querying the access record of the RCD system 403c. The RCD system 403c may also record other metrics relating to the terminating receiver 409 and the terminating receiver's 409 receipt of the call invite. The RCD system 403c may use a new unique link for each terminating receiver 409 and update the RCD access record to indicate that the terminating receiver 409 associated with a particular unique link has accessed that link and is configured to access RCD MEDIA. The RCD system 403c may record metrics in addition to determining if the terminating receiver 409 is configured to access RCD MEDIA. The metrics may include information such as whether the terminating receiver 409 experienced a non-ring event.

At 711, the originating network 403 may receive an SIP response from the terminating receiver 409 indicating that the terminating receiver 409 has received the call invite. After receiving the SIP response, the RCD system 403c may query the RCD access record, which may have recorded access of the link by the terminating user in addition to one or more metrics relating to the terminating user, to determine if the terminating receiver 409 accessed the RCD media file.

At 713, the RCD system 403c may send a notification to the originating source 401 indicating that the terminating receiver 409 accessed the RCD MEDIA. The notification may be an audio, video, haptic notification, or other kind of stimulus that may notify an operator of the originating source 401 that the terminating receiver 309 has accessed the RCD MEDIA. The originating source 401 may receive the SIP ringing response from the terminating receiver 309 to play a ringing tone.

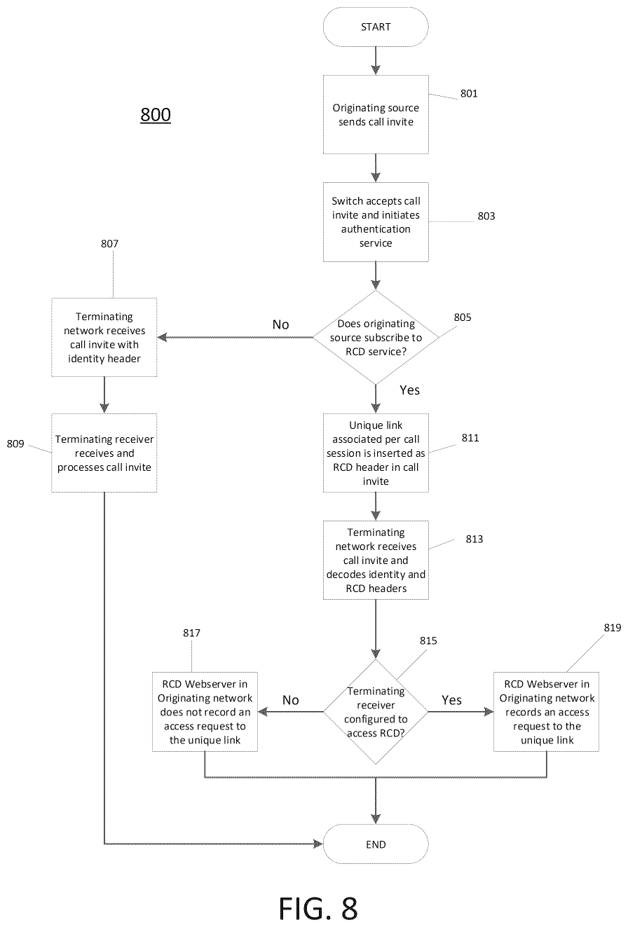

FIG. 8 depicts an example method 800 for recording RCD access. FIG. 8 is discussed with reference to previous FIGS. 3 and 4, however, it should be understood that these are just examples and the disclosure is not so limited. As shown in FIG. 8, in method 800, an originating source (e.g., originating source 301, 401) may send a call invite to a recipient device (e.g., terminating receiver 309, 409) at 801. The originating source 401 may send the call invite to the terminating receiver 409 through one or more transit networks (e.g., transit network 305, 405) and a terminating network (e.g., terminating network 307, 407). At 803, a switch (e.g., 403a) of the originating network 403 accepts the call invite and initiates an authentication procedure. The authentication procedure may involve invoking an authentication service through one or more authentication systems (e.g., authentication system 403b). The authentication system 403b may include the use of a STIR/SHAKEN system. The authentication system 403b may assign an attestation level corresponding to a level of authenticity or security to the originating source 401. For example, in a STIR/SHAKEN framework, the STIR/SHAKEN system may assign one of three levels of attestation to the originating source 301: (A) full attestation; (B) partial attestation; or (C) gateway attestation.

At 805, an RCD system of the originating network 403 (e.g., RCD system 403c) may determine if the originating source 401 subscribes to an RCD service. If the system cannot determine that the originating source 401 subscribes to one or more RCD services, the process proceeds to 807. At 807, the originating network 403 may send the call invite to the terminating receiver 409 through one or more transit networks 405 and a terminating network 407. At 809, the terminating receiver 309 may receive and process the call invite without RCD MEDIA.

If the RCD system 403c determines that the originating source 301 subscribes to one or more RCD services, the system moves to 811. At 811, the RCD system 403c may append the originating ID's RCD profile to the call invite sent by the originating source 401. The RCD system 403c may insert a unique link associated per call session to the call invite. The unique link may refer to a link that enables the RCD system 403c to track and monitor access of the RCD by one or more users. For example, the unique link may be a link that is only accessible by one terminating receiver 309. The unique link may be a link that is accessible by more than one user wherein the RCD system 403c is capable of tracking access of the RCD by terminating receivers and correlating that access to a time of call.

At 813, the terminating network 407 may receive the call invite. The terminating network 407 may comprise other sub-systems such as one or more of a switch, a billing server, a call log server, and an authentication system. The terminating network 407 or one of its sub-systems may decode one or more headers relating to authentication level, RCD, and originating source ID. The terminating network 407 may perform an authentication procedure, wherein the terminating network may decode the identity headers of the appended call invite and determine if the attestation level granted to the call invite by the authentication system (e.g., authentication system 403a) of the originating network is valid.

At 815, the RCD system 403c may determine if the terminating receiver 409 is configured to access the RCD media. The RCD system 403c may maintain an RCD access record. The RCD access record may be updated by including all or some times of access for each unique link. For example, originating source 401 may send a call invite appended with a unique link in the RCD header to a first terminating receiver (e.g., similar to terminating receiver 309, 409) at a first time and send a call invite appended with the same unique link to a second terminating receiver at a second time. The RCD system 403c may update the RCD access record to indicate whether the unique link was accessed at a first time and/or a second time. The RCD system 403c may determine that the terminating receiver 409 accessed the RCD by querying the access record of the RCD system 403c. The RCD system 403c may also record other metrics relating to the terminating receiver 409 and the terminating receiver's 409 receipt of the call invite. The RCD system 403c may use a new unique link for each terminating receiver 409 and update the RCD access record to indicate that the terminating receiver 409 associated with a particular unique link has accessed that link and is configured to access RCD media file.

The RCD system 403c may record metrics in addition to determining if the terminating receiver 409 is configured to access the RCD media file. The metrics may include information such as whether the terminating receiver 409 experienced a non-ring event. A non-ring event may occur when the terminating receiver 409 is in a non-ring state such as a do-not-disturb or other similar setting at the time that the it received the call invite. The RCD system 403c may record one or more of these events and associate them to terminating receivers.

If the RCD system 403c determines that the terminating receiver 409 is not configured to access RCD, the process moves to 817. At 817, the RCD webserver in originating network 403 may not record an access request to the unique link associated with the terminating receiver 409. Alternatively, the RCD webserver in originating network 403 may record that there was no access request registered to the unique link. If the terminating receiver 409 is configured to access RCD, the process moves to 819. At 819, the RCD webserver in originating network 403 may record an access request to the unique link associated with the terminating receiver 409. The RCD webserver in originating network 403 may update the RCD access record to indicate whether the terminating receiver 409 accessed or didn't access the RCD media file.

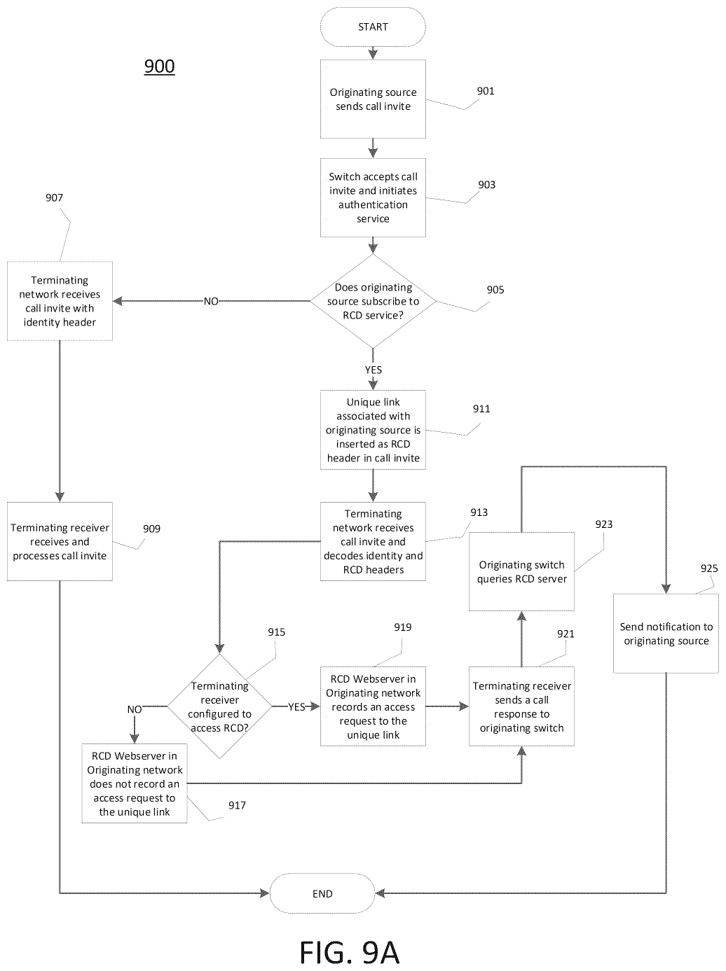

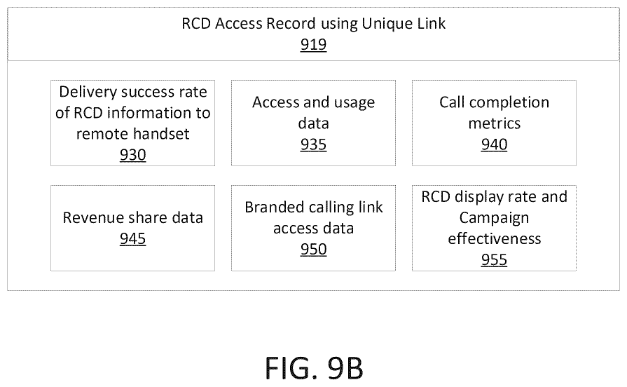

FIG. 9A depicts an example method 900 for recording RCD access by terminating receivers and sending live notifications with respect to the determination of whether the terminating receiver is capable of receiving RCD to an originating source. For ease of explanation, FIG. 9A is discussed with reference to previous FIGS. 3 and 4, however, it should be understood that these are just examples and the disclosure is not so limited. As shown in FIG. 9A, the originating source (e.g., 301, 401) may send a call invite to a recipient device (e.g., terminating receiver 309, 409). The originating source 401 may send the call invite to the recipient device (e.g., terminating receiver 409) through one or more transit networks (e.g., 305, 405) and a terminating network (e.g., 307, 407) at 901. At 903, a switch (e.g., switch 403a) of the originating network 403 accepts the call invite and initiates an authentication procedure. The authentication procedure may include the use of an authentication system (e.g., authentication system 403b). The authentication system may be a STIR/SHAKEN system. The authentication system 403b may assign a level of attestation corresponding to a level of authenticity or security to the originating source 401. For example, in a STIR/SHAKEN framework, the STIR/SHAKEN system may assign one of three levels of attestation to the originating source 401: (A) full attestation; (B) partial attestation; or (C) gateway attestation.

At 905, the RCD system 403c may determine if the originating source 401 subscribes to an RCD service. If the system cannot determine that the originating source 401 subscribes to one or more RCD services, the process proceeds to step 907. At 907, the system may send the call invite to the recipient device (e.g., terminating receiver 409) through one or more transit networks 405 and a terminating network 407. At 909, the terminating receiver 409 may receive and process the call invite without RCD MEDIA. The process may end after step 909. Additionally, or alternatively, the system may then proceed to step 921, wherein the terminating receiver 409 may send a call response to the originating switch 403a.

If the system determines that the originating source 401 subscribes to one or more RCD services, the system moves to 911. At 911, the RCD system 403c may add a unique link to the call invite sent by originating source 401. The unique link may refer to a link that enables the RCD system 403c to track and monitor access of the RCD by one or more users. For example, the unique link may be a link that is only accessible by one terminating receiver 409 The unique link may be a link that is accessible by more than one user wherein the RCD system 403c is capable of tracking access of the RCD by terminating receivers and correlating that access to a time of call.

At 913, the terminating network 407 may receive the call invite. The terminating network 407 may comprise other sub-systems such as one or more of a switch, a billing server, a call log server, and an authentication system. The terminating network 407 or one of its sub-systems may decode one or more headers relating to authentication level, RCD, and originating source ID. The terminating network 407 may perform an authentication procedure.

At 915, the RCD system 403c may determine if the terminating receiver 309 is configured to access the RCD media file. The RCD system 403c may maintain an RCD access record. The RCD access record may be updated by including all or some times of access for each unique link. For example, originating source 401 may send a call invite appended with a unique link in the RCD header to a first terminating receiver (e.g., similar to terminating receiver 309, 409) at a first time and send a call invite appended with the same unique link to a second terminating receiver at a second time. The RCD system 403c may update the RCD access record to indicate whether the unique link was accessed at a first time and/or a second time. The RCD system 403c may determine that the terminating receiver 309 accessed the RCD by querying the access record of the RCD system 403c. The RCD system 403c may also record other metrics relating to the terminating receiver 409 and the terminating receiver's 409 receipt of the call invite. The RCD system 403c may use a new unique link for each terminating receiver 409 and update the RCD access record to indicate that the terminating receiver 409 associated with a particular unique link has accessed that link and is configured to access the RCD media file.

If the terminating receiver 309 is not configured to access RCD (e.g., does not have the display on the phone), the process moves to 917. At 917, the RCD webserver in the originating network 403 may not record an access request to the unique link associated with the terminating receiver 409. Alternatively, the RCD system may record that there was no access request registered to the unique link.

If the terminating receiver 409 is configured to access RCD, the process moves to 919. At 919, the RCD webserver in the originating network 403 may record an access request to the unique link associated with the terminating receiver 409. The RCD system 403c, in either step, may update the RCD access record to indicate access or no access.

At 921, the terminating receiver 409 may send an SIP response to the originating switch 403a. The originating switch 403a may receive the SIP response. The originating switch 403a may direct the RCD system 403c to query the RCD access record. After receiving the SIP response, the RCD system 403c may query the RCD access record, which may have recorded access of the link by the terminating user in addition to one or more metrics relating to the terminating user, to determine if the terminating receiver 409 accessed the RCD media file.

At 923, the RCD system 403c may send a notification to the originating source 401 indicating that the terminating receiver 409 accessed the RCD MEDIA. The notification may be an audio, video, haptic notification, or other kind of stimulus that may notify an operator of the originating source 401 that the terminating receiver 409 has accessed the RCD MEDIA. The originating source 401 may receive the SIP ringing response from the terminating receiver 409 and play a ringing tone to a user operating originating source 401.

FIG. 9B shows examples of the advantages provided by the RCD access record using a unique link 919. The RCD access record enables the tracking of successful deliveries (e.g., delivery success rate) of RCD information to a remote handset 930. The RCD access record may be periodically ingested by a mediation server for further processing. For example, the mediation server may correlate Call Detailed Record (CDR) files from the switch, the RCD Web Server, and other network elements. The CDR may be stored into a Unified CDR database. An RCD report generator can pull the CDR data from the Unified CDR database to generate desired reports based on user preferences, settings, and key filters. The RCD reports may be generated to measure the revenue share. The revenue share data 945 may be offered with mobile carriers when RCD is displayed to the terminating user as opposed to a call invite with RCD sent to a peering partner. In another example, the mediation server may additionally send the consolidated CDR file data to billing systems to process the CDR information to create monthly invoices for subscribers and carrier compensation. Call log servers may access the UCDRs to allow subscribers to view their call activity via subscriber portals. Subscribers with RCD service may be able to view that the RCD was or was not accessed by a terminating handset. The originating carrier may track when RCD multi-media links are accessed by the called party using a unique call specific identifier embedded in the link. The originating service provider may then track access and usage 935 (e.g., access data, usage data) by the specific individual call identifier and offer reporting with metrics, such as how much call answer rates improve over calls where RCD data is not accessed (e.g., call completion data, call completion rates, call completion metrics 940). By analyzing call completion metrics 940 and branded calling link access data 950, the delivery success rate may be measured and detailed reports that include RCD display rate and campaign effectiveness 955 may be generated.

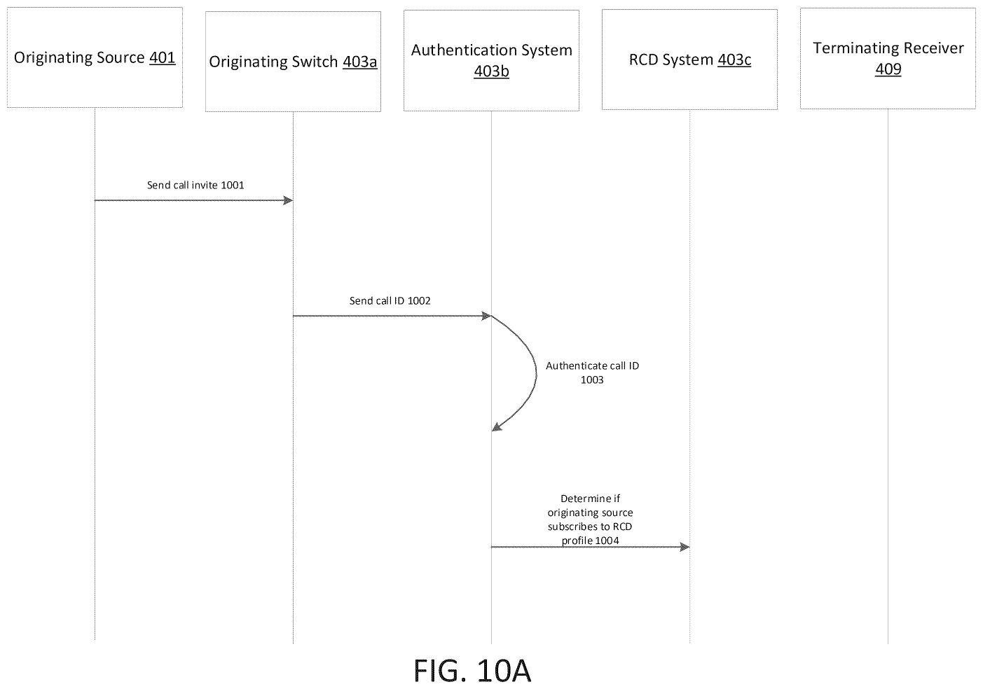

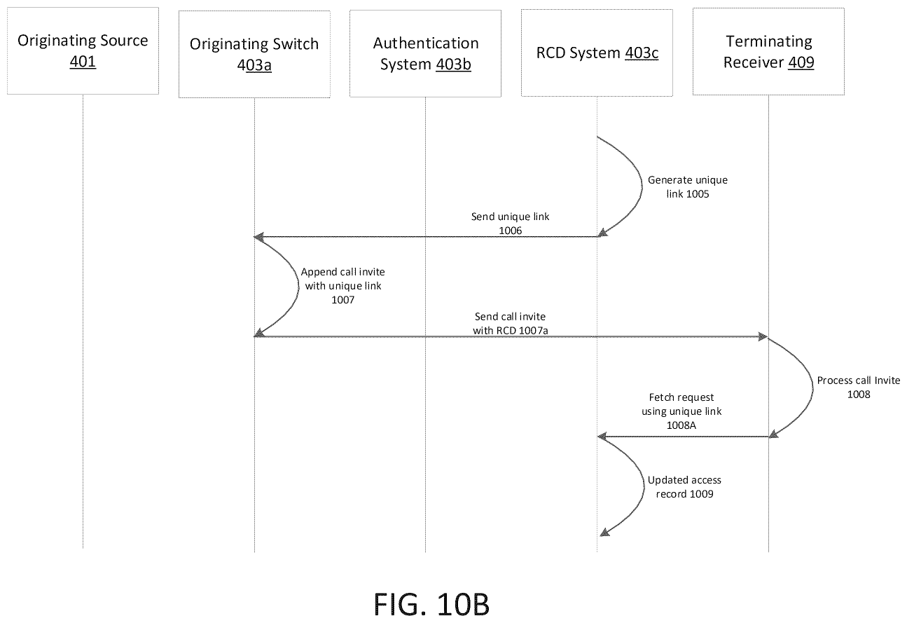

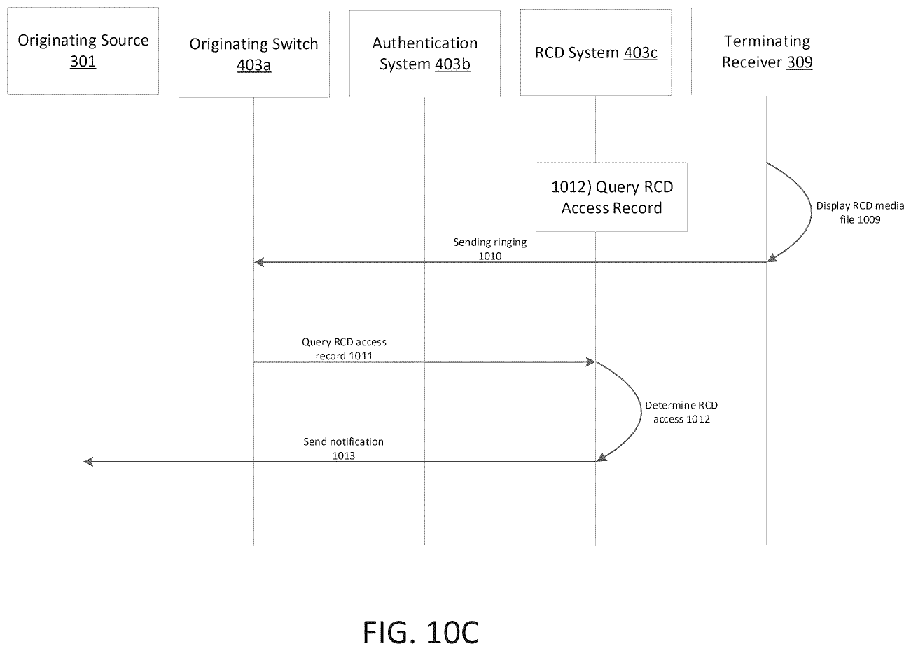

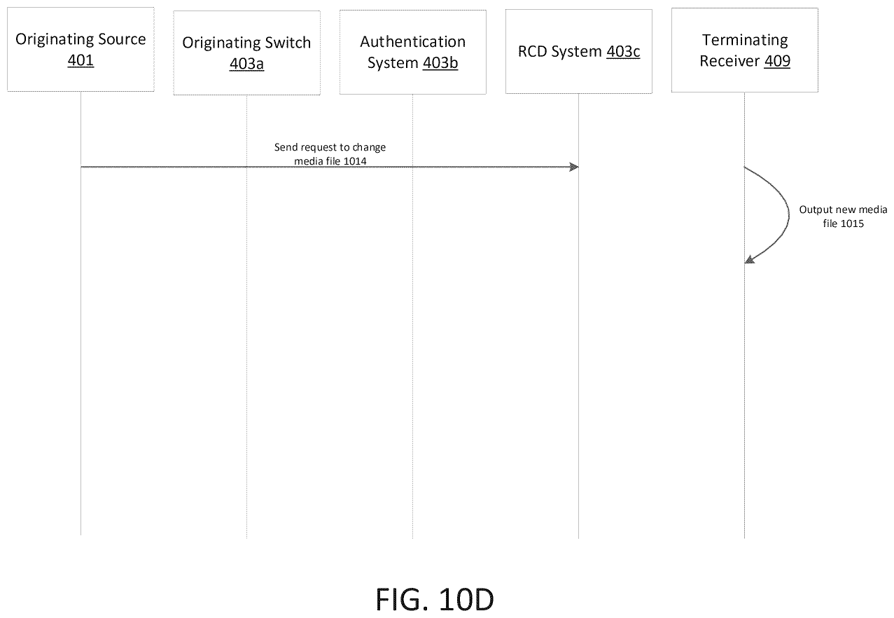

FIGS. 10A and 10B depict an example process flow of FIG. 8. At 1001, an originating source (e.g., originating source 301, 401) may send a call invite to an originating switch (e.g., originating switch 403a) of originating network (e.g., originating network 303, 403). The call invite may contain an originating source ID. The originating switch 403a may accept the call invite.

At 1002, the originating switch 403a may invoke an authentication procedure to grant an attestation level to the call invite. The authentication procedure may be performed by an authentication system (e.g., authentication system 403b). The originating switch 403a may send the call invite or one or more of its constituents to the authentication system 403b to perform the authentication procedure

At 1003, the authentication system 403b may perform the authentication procedure. The authentication procedure may be STIR/SHAKEN procedure performed by a STIR/SHAKEN system. The originating switch 403a may send the call invite or part or all of the information of the call invite to the authentication system 403b. The authentication system 403b may assign a level of attestation corresponding to a level of authenticity or security to the originating source 401. For example, in a STIR/SHAKEN framework, the STIR/SHAKEN system may assign one of three levels of attestation to the originating source 301: (A) full attestation; (B) partial attestation; or (C) gateway attestation.

At 1004, an RCD system (e.g., RCD system 403c) may determine if the originating source 401 subscribes to one or more RCD services. For example, an entity may have one phone number and have one RCD profile. An entity may have one phone number multiple extensions, each subscribing to an RCD profile of the entity. (e.g., billing personnel's extensions may have an RCD profile whereas sales personnel may have another). An entity may have multiple phone numbers, each indicating different department, type of personnel, location of personnel, etc. The RCD system 403c may add the originating ID's RCD information to a call invite of the originating source 401.

At 1005, the RCD system 403c may generate a unique link to append to the call invite. The RCD system 403c may send the unique link to the authentication system 403b or another sub-system of the originating network 403. The unique link may refer to a link that enables the RCD system 403c to track and monitor access of the RCD by one or more users and make that RCD information accessible to the terminating receiver 409. For example, the unique link may be a link that is only accessible by one terminating receiver 409. The unique link may be a link that is accessible by more than one user wherein the RCD system 403c is capable of tracking access of the RCD by terminating receivers and correlating that access to time of call. At 1006, the RCD system 403c may send the unique link to the originating switch 403a.

At 1007, the originating switch 403a may append the call invite with the unique link. At 1007a, the originating switch 403a may send the call invite with the RCD information (the unique link appended to the RCD header) to a terminating receiver (e.g., terminating receiver 309, 409). The originating switch 403a may send the call invite through one or more transit networks (e.g., transit network 305, 405). The call invite may be received by a terminating network (e.g., terminating network 307, 407). The terminating network 407 may comprise other sub-systems such as one or more switches, a billing server, a call log server, and an authentication system. The terminating network 407 or one of its sub-systems may decode one or more headers relating to authentication level, RCD, and originating source ID. The terminating network 407 may perform an authentication procedure. The terminating network 407 may send the call invite to the terminating receiver 409.

At 1008, the terminating receiver 409 may process the call invite, and if it has the capability to support and output the RCD media file, it may resolve the unique RCD media file link and issue a fetch request to the RCD system 403c to receive the RCD media file. At 1008a, the terminating receiver 409 may fetch the request using the unique link.

At 1009, the RCD system 403c may update an RCD access record. The RCD access record may be updated by including all or some times of access for each unique link. The RCD system 403c may update the RCD access record to indicate that the unique link was accessed at a first time and a second time. The RCD system 403c may also record other metrics relating to the terminating receiver 309 and the terminating receiver's 409 receipt of the call invite. The RCD system 403c may use a new unique link for each terminating receiver 409 and update the RCD access record to indicate that the terminating receiver 409 associated with a particular unique link has accessed that link and is configured to access the RCD media file. The RCD system 403c may record metrics in addition to determining if the terminating receiver 409 is configured to access the RCD media file. The metrics may include information such as whether the terminating receiver 409 experienced a non-ring event.

FIGS. 10A-10D show the example process flow of FIG. 9A. At 1010, the terminating receiver 409 may display the one or more RCD media files. The one or more RCD media files may be a brand logo, icon a reason for a call, or other media. At 1010, the terminating receiver 409 may send an SIP response to the originating source 401, indicating that it has received the call invite and is ringing. The originating switch 403a may receive the SIP response through one or more transit networks 405.

At 1011, the originating switch 403a may direct the RCD system 403c to query the RCD access record. At 1012, The RCD system 403c may determine if the terminating receiver 409 accessed the unique link by determining that the unique link associated with the terminating receiver ID was accessed.

At 1013, the RCD system 403c may send one or more notifications to the originating source 401 to indicate that the terminating receiver 409 accessed the RCD media file. The RCD system 403c may send the notification through one or more transit networks 405 and the originating switch 403a. The originating switch 403a may send the terminating receiver's 409 SIP response to the originating source 401.

At 1014, the originating source 401 may send a request to change the RCD media file to a different media file or an interactive media file. The request may be directed by an operator of the originating source 401. The new media file may be output while the call remains ringing. The new media file may also continue to be output after the call invite has been accepted. The RCD interactive media may be a dynamic media file that is relevant to the call reason and the terminating receiver 409. For example, a customer service call relating to tech support may show a tutorial, screenshare of a human or non-human operator of the originating source 401, or other relevant media as the interactive media file. The RCD interactive media may include two-factor authentication. Additionally, or alternatively, the RCD interactive media may include multi-factor authentication.

At 1015, the terminating receiver 409 may output the changed interactive media file. The terminating receiver 409 may continue to access the media file from RCD system 403c using the unique link that was appended to the call invite. A change to the media file that is accessed using the unique link may be output to the terminating receiver 409.

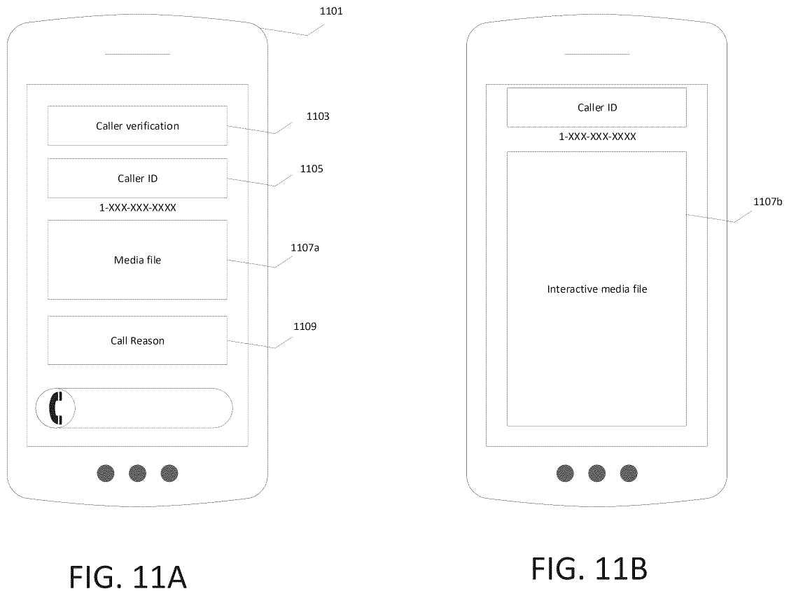

FIG. 11A depicts a terminating receiver 1100. The terminating receiver 1100 may be similar to terminating receivers 309 and 409, but the disclosure is not so limiting. Terminating receiver display 1101 may be configured to access RCD after receiving a call invite containing RCD and before the terminating receiver 409 accepts the call invite. The terminating receiver 409 may output a caller verification symbol 1103 indicating the level of attestation that the originating receiver ID was granted by the authentication system 403b (e.g., the STIR/SHAKEN server may grant full attestation which may be outputted by the terminating receiver 409 display as a checkmark). The terminating receiver display 1101 may output the caller ID 1104 as a terminating network (e.g., terminating network 307, 407) may decode from the ID header in the call invite. The terminating receiver display 1101 may output one or more RCD media files 1107a. The one or more RCD media files may be sent to the terminating receiver 409 by an originating source (e.g., originating source 301, 401) using the RCD system 403c. The terminating receiver 1100 may access the one or more RCD media files by accessing the unique link included in the call invite and output it as a media file 1107a. the terminating receiver display 1101 may output a call reason 1109 as included in the RCD media file.

FIG. 11B shows a terminating receiver 1100 after accepting the call invite. One or more indicators such as the call reason 1109, media file 1107a, caller ID 1105 or caller verification 1103 may no longer be outputted by the terminating receiver display 1101 while the call is in progress. Terminating receiver display 1101 may continue to output the RCD media file while the call is in progress. The RCD media file may remain the same or it may change to an interactive RCD media file 1107b. For example, the RCD interactive media file 1107b may change to a different media. The RCD interactive media file 1107b may be a dynamic media file that is relevant to the call reason 1107a and the terminating receiver 1101. For example, a customer service call relating to tech support may show a tutorial, screenshare of a human or non-human operator of the originating source 401, or other relevant media as the interactive media file.

Although examples are described above, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the disclosure. Accordingly, the foregoing description is by way of example only, and is not limiting.

1. A method comprising:
receiving a call invite from an originating source;
determining that the call invite is associated with Rich Call Data (RCD);
sending the call invite to a recipient device, wherein the call invite comprises:
an identity header; and
an RCD header comprising a unique link to a server comprising one or more RCD media files associated with the originating source; and
causing, based on the unique link, the recipient device to indicate access of the one or more RCD media files.

2. The method of claim 1, further comprising recording metrics relating to the recipient device, wherein the recording metrics comprise:
an originating ID of the recipient device;
a first indication associated with a non-ring event; and
a second indication associated with an accepted call invite.

3. The method of claim 1, further comprising:
receiving an indication that the recipient device received the call invite; and
determining if the recipient device is configured to access RCD by:
identifying an originating ID of the recipient device;
identifying the unique link contained in the call invite; and
determining that the unique link contained in the call invite was accessed.

4. The method of claim 1, wherein the one or more RCD media files relevant to the originating source are customizable to the recipient device.

5. The method of claim 1, further comprising determining authenticity of the originating source.

6. The method of claim 1, further comprises receiving an indication that the recipient device has performed one or more human ID authentication steps, wherein the one or more RCD media files is altered.

7. The method of claim 1, wherein the one or more RCD media files comprises at least one of an interactive media file, a brand logo, or an icon.

8. The method of claim 2, wherein the non-ring event is caused by the recipient device being in a non-ring state.

9. The method of claim 2, wherein the non-ring event is caused by an analytics engine.

10. The method of claim 1, wherein the one or more RCD media files further comprises one or more of delivery success rates, access data, usage data, call completion data, and revenue share data.

11. The method of claim 1, wherein the one or more RCD media files further comprises an indication stating a reason for the call invite.

12. The method of claim 4, further comprising:
sending a notification to the originating source indicating that the recipient device accessed the unique link; and
receiving a response to a request for the one or more RCD media files encoded by the unique link.

13. A method comprising:
receiving, by a recipient device, a call invite associated with Rich Call Data (RCD), the call invite comprising:
an identity header; and
an RCD header comprising a unique link to a server containing one or more RCD media files associated with an originating source; and
sending a notification, based on the unique link, wherein the notification indicates that the RCD header has been accessed.

14. The method of claim 13, wherein the one or more RCD media files comprises at least one of an interactive media file, a brand logo, or an icon.

15. The method of claim 13, further comprises receiving an indication that the recipient device has performed one or more human ID authentication steps, wherein the one or more RCD media files is altered.

16. A method comprising:
receiving, by a recipient device, a call invite associated with Rich Call Data (RCD), the call invite comprising:
an identity header; and
an RCD header comprising a unique link to a server containing one or more RCD media files relevant to an originating source;
tracking access, via the recipient device, of the RCD header; and
correlating the access to a time of call.

17. The method of claim 16, wherein the one or more RCD media files comprises a brand logo.

18. The method of claim 16, wherein the one or more RCD media files comprises an indication of a reason for the call invite.

19. The method of claim 16, wherein the one or more RCD media files remain accessible to the recipient device after the recipient device has accepted the call invite.

20. The method of claim 16, further comprising:
sending an indication that the recipient device received the call invite; and
configuring the recipient device to access RCD by:
identifying the ID of the recipient device;
identifying the unique link contained in the call invite; and
determining that the unique link contained in the call invite was accessed.
